(19) United States
(12) Patent Application Publication
(10) Pub. No.: US 2008/0053513 A1
(43) Pub. Date: Mar. 6, 2008

(54) System for providing continuous electric power from solar energy

(75) Inventor: William Robert Palmer, Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/516,219

(22) Filed: Sep. 6, 2006

(51) Int. Cl. H02N 6/00

(52) U.S. Cl. 136/246; 136/248

(57) ABSTRACT

A system (112) for providing continuous electric power from solar energy is provided. The system includes a solar concentrator (302) formed of an optically reflective material having a curved surface that defines a focal center or a focal line toward which light incident on the curved surface is reflected. The system also includes a PV/thermal device (310) positioned substantially at the focal center or along the focal line. The PV/thermal device is comprised of a photovoltaic array (500) and a fluid cooling system for the photovoltaic array. The fluid cooling system includes a thermal energy collector (504). A battery charging system (118) is coupled to the photovoltaic array. The battery charging system includes a battery charging circuit. The battery charging system is programmed to selectively provide a charging current for the battery charging circuit during periods when the solar concentrator is exposed to solar radiation. The charging current can be selected so that a battery (120) charged by the battery charging circuit has power to continuously operate a load during periods when the solar concentrator is not exposed to solar radiation.

### BACKGROUND OF THE INVENTION

1. Statement of the Technical Field

The invention concerns power systems, and more particularly, hybrid solar power systems that can convert solar energy into electric power.

2. Description of the Related Art

There are currently in use a wide variety of systems and methods for utilizing solar power as a source of energy. For example, photovoltaic systems are widely known for converting sunlight into electricity. Another common type of system is the solar trough. The solar trough is a type of solar thermal system where sunlight is concentrated by a curved reflector onto a pipe containing a working fluid that can be used for process heat or to produce electricity. Solar thermal electric power plants using solar trough technology are well known.

A variation of the solar trough technology is a photovoltaic concentrator system. The photovoltaic concentrator system uses sun-tracking mirrors that reflect light onto a receiver lined with photovoltaic solar cells. The mirrors concentrate the incident solar energy on the solar cells so that they are illuminated with approximately 25 times normal solar concentration. Such systems can convert at an efficiency of about 20%. The balance of the solar energy is converted into heat. However, the solar cells have an upper temperature limit of about 200° C. Accordingly, excess heat must be removed. Typically, this is accomplished by means of a cooled heat exchanger attached to the photovoltaic solar cells. For example, the photovoltaic cells can be provided with an integrated passive heat sink to maintain the solar cells at a moderate temperature.

Despite the advantages offered by the foregoing systems, they still have not achieved a level of efficiency necessary for certain applications. For example, near space vehicles may be used in different applications, such as monitoring troops, surveillance of combatants, delivery of communications, and/or disaster area monitoring. Future near space vehicles are envisioned to travel between 60,000 feet to 80,000 feet above sea level. Consequently, near space vehicles will travel above the reach of conventional weapon systems and free from the threat of weather interference.

Current concept designs of long endurance near space vehicles are limited by their payload and propulsion capabilities. One limitation comes from a near space vehicle's dependency on fuel to power propulsion systems and onboard components, such as radars, sensors, imaging devices, control systems, and radio transmitters. A large amount of weight is invested to carrying a sufficient amount of fuel for flight. Consequently, the overall capabilities of a near space vehicle are limited.

Future near space vehicles are also envisioned to be powered by batteries. For example, a near space vehicle can utilize a lithium battery to power its propulsion systems and onboard components. The current designs of battery powered near space vehicles are also limited by their endurance capabilities. A near space vehicle's duration of flight is dependant on the energy density and life of the battery.

Despite the various power technologies known in the art there remains a need for a small near space vehicle powered by a system that assures improved endurance capabilities. A near space vehicle design is also needed that is able to function twenty four hours a day, seven days a week (24/7), providing coverage of a strategic location on the earth to various users. A near space vehicle design is also needed with a propulsion and payload capacity that does not utilize any kind of embarked fuel. In order to accomplish such a near space vehicle design, an integrated, flexible system is needed for remote power generation. A power system is also needed that can provide instantaneous power to electrical systems. A power system is further needed that is capable of converting solar energy to both thermal energy and electric energy efficiently in air temperatures (e.g., −60° F.) of near space altitudes (e.g., 60,000 feet above sea level). In order to convert 40% or more of the sun's incident energy into electric power, different architectures are required.

### SUMMARY OF THE INVENTION

The invention concerns a system for providing continuous electric power from solar energy. The system includes a solar concentrator formed of an optically reflective material having a curved surface. The curved surface defines a focal center (or a focal line) toward which light incident on the curved surface is reflected. The system also includes a PV/thermal device positioned substantially at the focal center (or along the focal line). The PV/thermal device is comprised of a photovoltaic array and a fluid cooling system for the photovoltaic array. The fluid cooling system includes a thermal energy collector. The thermal energy collector is coupled to a thermal energy converter that converts thermal energy, removed from the photovoltaic array, to electric power. The system can be disposed in a fixed location or located on a vehicle for mobile operation.

According to an aspect of the invention, a battery charging system is coupled to the photovoltaic array, the thermal energy converter, or both. The battery charging system includes a battery charging circuit. The battery charging system is programmed to selectively provide a charging current for the battery charging circuit during periods when the solar concentrator is exposed to solar radiation. Either or both of the photovoltaic array and the thermal energy converter is also arranged to provide power to a load. The charging current can be selected so that a battery charged by the battery charging circuit has power to continuously operate a load during periods when the solar concentrator is not exposed to solar radiation. In this regard, the system also includes a battery. The battery is selected to have an amp-hour rating to continuously power all or part of the load during periods when the solar radiation is not available (nighttime hours) The load can include a propulsion system for the vehicle and/or electronic equipment onboard the vehicle.

According to another aspect of the invention, the system includes a thermal interface between the thermal energy collector and the photovoltaic array. The thermal interface defines a thermally conductive path for communicating heat from the photovoltaic array to the thermal energy collector (for example, a heat exchanger). The thermal energy collector has one or more fluid conduits containing a working fluid. A fluid transport system is provided for continuously circulating the working fluid between the thermal energy converter and the thermal energy collector when the solar concentrator is exposed to a source of solar radiation. The thermal energy converter is further comprised of an engine powered by the working fluid. The engine drives an electric generator. The thermal energy converter can further include at least one heat exchanger that is arranged for transferring heat from the working fluid to an ambient air. For example, the heat exchanger can transfer heat from the working fluid to an atmosphere surrounding a near space vehicle.

According to another aspect of the invention, the system includes a support structure for the solar concentrator. The support structure advantageously includes one or more movable portions for varying a position or an orientation of the solar concentrator.

When installed on a vehicle, the system includes an electric power distribution system. The electric power distribution system includes at least one circuit configured for distributing power to the load on the vehicle. The load will generally include a propulsion system of the vehicle. The electric power distribution system will also generally include one or more circuits configured for distributing power to electronic equipment onboard the vehicle. It should be appreciated that the vehicle can be designed for flight. In this regard, the vehicle will include a lift system. For example, the lift system can be designed for carrying the vehicle to a near space altitude. The vehicle will also include a control system programmed for controlling a position of the vehicle. The control system can also be programmed for controlling an orientation of the solar concentrator. According to one aspect, the control system can cooperatively control the position of the vehicle and the orientation of the solar concentrator so that the solar concentrator is constantly pointed toward a source of solar radiation.

A method for generating electric power from solar energy is also provided. The method includes exposing a solar concentrator to a source of solar radiation. The solar concentrator is selected to include an optically reflective material having a curved surface. The curved surface defines a focal center (or a focal line) toward which light incident on the curved surface is reflected. The method also includes positioning a PV/thermal device substantially at the focal center (or along the focal line).

The PV/thermal device includes a photovoltaic array and a thermal energy collector comprised of a fluid cooling system. The method includes cooling the photovoltaic array with the fluid cooling system. Thermal energy collected by the fluid cooling system is transported to a thermal energy converter. Electric power is generated using the photovoltaic array and by the thermal energy converter using the heat collected by the fluid cooling system. The method can be implemented at a fixed location or onboard a vehicle designed for flight.

During daylight hours, when the solar concentrator is exposed to thermal energy, the method includes using the electricity generated by the photovoltaic array and/or the thermal energy converter to power a load. The method also includes using the electric power generated by the photovoltaic array, the thermal energy converter, or both to charge a battery. The charging current of a battery charging circuit is selectively controlled during periods when the solar concentrator is exposed to solar radiation to achieve a desired charging effect. The amp-hour rating of the battery and the battery charging current can be selected so that the battery has sufficient power to continuously operate a load during periods when the solar concentrator is not exposed to solar radiation. In the case where the method is implemented in a vehicle, the load will generally include a propulsion system and/or onboard electronic equipment.

According to an aspect of the invention, the method includes communicating heat from the photovoltaic array to the thermal energy collector through a thermal interface. A working fluid is contained within a fluid conduit of the thermal energy collector. The working fluid is heated by solar radiation as it is circulated through the fluid conduits. Subsequently, the heated working fluid goes through a gas expansion process that is used to power an engine. The engine drives an electric generator to produce electric power.

When used in terrestrial applications, electric power generated by the photovoltaic array and/or the thermal converter is supplied to an electric power distribution system. The electric power distribution system supplies electric power to a propulsion system and/or electronic equipment.

The method can also include positioning the vehicle at a near space altitude (e.g., 60,000 feet above sea level). When positioned in this way, a temperature differential between a working fluid and a surrounding atmosphere (e.g., −60° F.) at the near space altitude is used to power an engine disposed in the vehicle. The method also advantageously includes selectively controlling a position of the vehicle. The method can further include selectively controlling an orientation of the solar concentrator such that the solar concentrator is constantly facing a source of solar radiation. According to one aspect of the invention, a control system can control the position/orientation of the vehicle and the orientation of the solar concentrator onboard the vehicle so that the solar concentrator constantly faces a source of solar radiation.

### BRIEF DESCRIPTION OF THE DRAWINGS

Embodiments will be described with reference to the following drawing figures, in which like numerals represent like items throughout the figures, and in which:

FIG. 1 is schematic illustration of a near space vehicle that is useful for understanding the invention.

FIG. 2 is a cross-sectional view of the near space vehicle of FIG. 1 taken along line 2-2.

FIG. 3 is a cross-sectional view of the near space vehicle of FIG. 1 taken along line 3-3.

FIG. 4 is a block diagram of a near space vehicle hardware architecture that is useful for understanding the invention.

FIG. 5 is a block diagram of a power system for a near space vehicle that is useful for understanding the invention.

FIG. 6 is an illustration that is useful for understanding the structure of a solar energy collector.

FIG. 7 is a cross-sectional view of the solar energy collector of FIG. 6 that is useful for understanding the invention.

FIG. 8 is an illustration that is useful for understanding the structure of a solar energy collector array.

FIG. 9 is top view of a photovoltaic array and a thermal energy collector that is useful for understanding the invention.

FIG. 10 is a cross-sectional view of the photovoltaic array in FIG. 9 taken along line 10-10.

FIG. 11 is a schematic illustration of a thermal energy converter that is useful for understanding the invention.

FIG. 12 is a flow diagram illustrating a thermal energy conversion flow process that is useful for understanding the invention.

FIG. 13 is a process flow diagram that is useful for understanding a method for powering a near space vehicle.

### DETAILED DESCRIPTION OF THE PREFERRED EMBODIMENTS

The invention concerns a system for generating electric power from solar energy. The system includes a solar energy collector that has a reflective surface. The reflective surface is a solar concentrator formed into a shaped surface for focusing solar radiation toward an elongated solar energy collection zone provided at a focal center (or along a focal line) defined by the reflective surface. An elongated PV/thermal device is positioned at the focal center (or along the focal line) within the solar energy collection zone. The PV/thermal device includes a photovoltaic array and a thermal energy collector. The photovoltaic array converts solar energy into electrical power. The thermal energy collector has fluid conduits to provide passageways for the flow of a working fluid. The working fluid collects thermal energy as it flows through the thermal energy collector. The working fluid is used by a thermal energy converter to convert the thermal energy to electric power. In this regard, it should be appreciated that the working fluid goes through a thermal energy expansion process. The working fluid also provides an active and effective mechanism for cooling the photovoltaic cells. The foregoing arrangement results in a relatively simple system that converts solar energy to electric power with a high efficiency.

The power system described herein can be used to power any system, such as fixed and mobile systems used in terrestrial applications where there exists a cold thermal sink (such as, a cold stream). However, the power system is especially advantageous for use in powering a vehicle intended for high altitude flight operations where there exists an available thermal sink (such as, a cold ambient air). For example, the present invention can be implemented in or on a near space vehicle. One significant advantage of using the system in a near space vehicle application is the large temperature differential that is achieved between the heated working fluid and the very cold atmosphere that exists at near space altitudes. Accordingly, the following discussion describes the present invention in the context of a near space vehicle application. Still, it should be understood that this description is merely presented as one possible arrangement, and the invention is not limited in this regard.

Near Space Vehicle

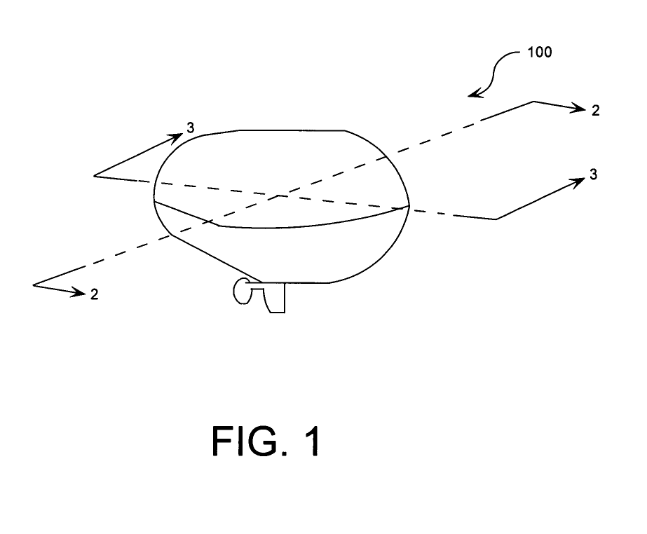

FIG. 1 is a schematic illustration of a near space vehicle 100 that is useful for understanding the invention. According to an embodiment of the invention, near space vehicle 100 can be an unmanned, solar powered airship that can maintain a geostationary position at altitudes ranging between 50,000 feet to 100,000 feet above sea level. However, the invention is not limited in this regard and the system can be used in other types of vehicles.

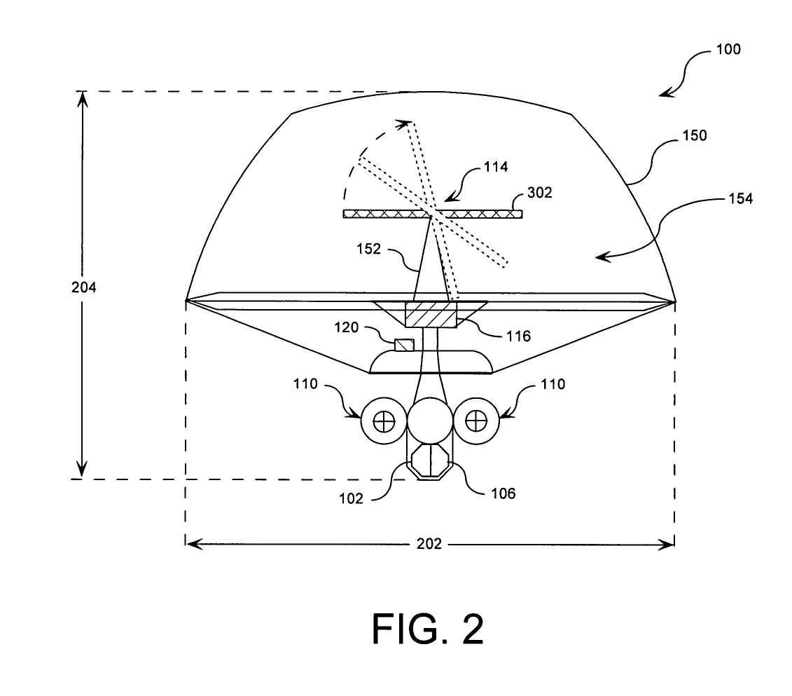

Referring now to FIG. 2, near space vehicle 100 is comprised of a lift system 154. The near space vehicle also includes a solar window 150, a solar energy collector 114, a thermal energy converter 116, a battery 120, and a propulsion system 110. Near space vehicle 100 can also include an imaging system 102 and a sensor system 106.

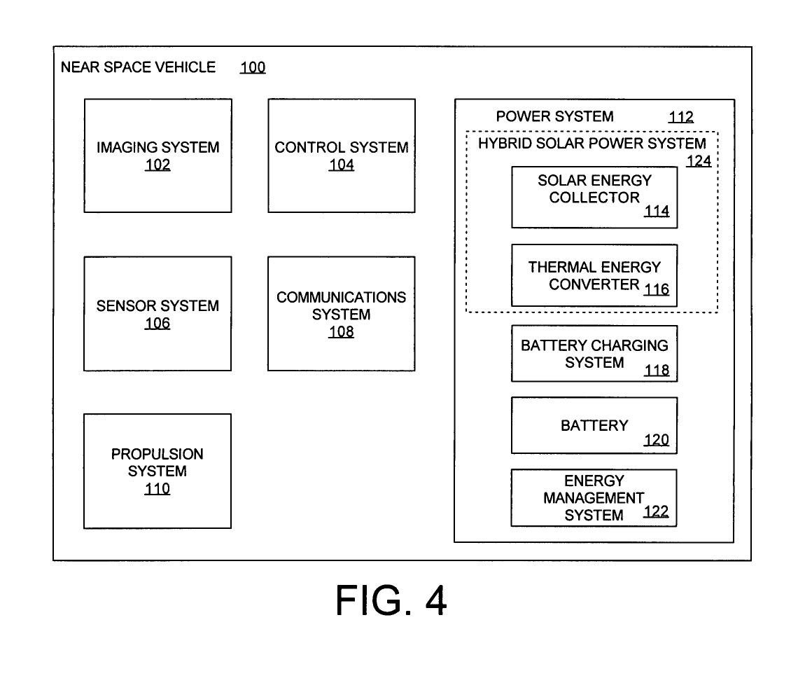

Lift system 154 provides lift to near space vehicle 100. According to one embodiment, lift system 154 is comprised of a lighter-than-air fluid (e.g., helium or hydrogen) contained in an interior vessel defined by near space vehicle 100. Propulsion system 110 controls the near space vehicle's direction of travel and can also control the vehicle's attitude (i.e., pitch, roll, and yaw). Propulsion system 110 is used for guiding a take off, guiding an ascent, guiding a decent, guiding a landing, and maintaining a geostationary position. For example, propulsion system 110 can be used to maintain a position where the solar energy collector constantly faces the sun. Propulsion system 110 will be described in further detail below (in relation to FIG. 4).

Solar window 150 provides an optical path which is used to expose solar energy collector 114 to a source of solar radiation (i.e. the sun). As such, the solar window 150 can be comprised of any optically transparent material suitable for operations at a near space altitude. Such materials can include transparent polymer films, glass or plastic without limitation.

Solar energy collector 114 is coupled to near space vehicle 100 by support pedestal 152. Support pedestal 152 can be a light weight structure comprised of any material commonly used in the art, such as a metal, metal alloy, composite material, or rigid polymer. The position of solar energy collector 114 can be adjusted by or in conjunction with support pedestal 152 such that a reflective surface 302 constantly faces the sun. For example, support pedestal 152 can be designed with a movable portion that forms an adjustment mechanism. The adjustment mechanism can include electronics, sensors, pivot joints, and servo-motors such that solar energy collector can be rotated and or pivoted about one or more axis. Such systems are well known in the art and can allow solar energy collector 114 to follow the movement of the sun.

According to another embodiment of the invention, an adjustment mechanism of support pedestal 152 can be used to place solar energy collector 114 in a sun pointing position. According to yet another embodiment of the invention, propulsion system 110 in conjunction with an adjustment mechanism of support pedestal 152 can be used to place solar energy collector 114 in a sun pointing position.

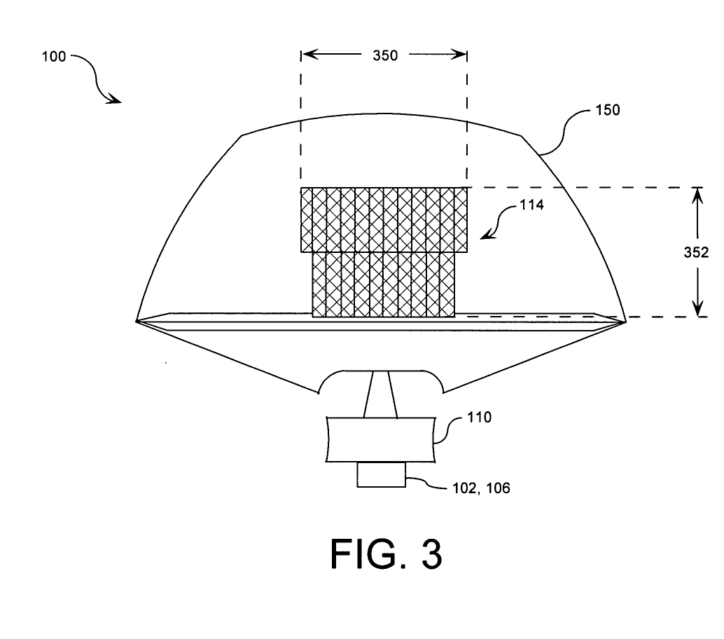

Referring now to FIG. 3, solar energy collector 114 has a height 352 and a length 350. A person skilled in the art will appreciate that height 352 and length 350 can be selected in accordance with a solar energy collector 114 application. For example, a desired electric power output of the solar power system can dictate the sizing of the solar energy collector 114.

Referring again to FIG. 2, the near space vehicle 100 can have a height 204, a length 202, and a width (not shown). A person skilled in the art will appreciate that the height 204, the length 202, and the width (not shown) can be selected in accordance with a near space vehicle 100 application. For example, the size of the vehicle can be selected so that the vehicle provides sufficient lift for the power system described herein and some predetermined payload. The payload can be selected in accordance with a near space vehicle application. A person skilled in the art will also appreciate that the structure of the near space vehicle 100 can be comprised of any material used in the art for high altitude balloons and airships, such as lightweight, high-strength fabrics, films, and composite materials.

A person skilled in the art will appreciate that the near space vehicle 100 architecture is one embodiment of an architecture in which the methods described below can be implemented. However, the invention is not limited in this regard and other suitable near space vehicle architectures can be used without limitation.

Near Space Vehicle Hardware Architecture

Referring now to FIG. 4, there is provided a block diagram of a near space vehicle 100 hardware architecture that is useful for understanding the invention. As shown in FIG. 4, near space vehicle 100 includes a power system 112, a propulsion system 110, and a control system 104. The near space vehicle 100 can also include an imaging system 102, a sensor system 106, and a communications system 108. For example, imaging system 102 can be comprised of a radar imaging system, a still camera, and/or a video camera for monitoring a strategic location on the earth. Control system 104 is advantageously comprised of one or more microprocessors programmed for controlling navigation of the near space vehicle 100 from a central location. Control system 104 can also be comprised of one or more microprocessors programmed for controlling the position of near space vehicle 100 by controlling the operation of propulsion system 110. Control system 104 can also be comprised of one or more microprocessors programmed for controlling an orientation of solar energy collector 114. Such control can include controlling an adjustment mechanism of support pedestal 152 such that solar energy collector 114 constantly points towards a source of solar radiation.

Propulsion system 110 can include a motor that is powered by electricity. Communications system 108 can be comprised of an antenna element, a radio transceiver, and/or a radio receiver. The components of the communications system are well known to persons skilled in the art. Thus, the listed components will not be described in detail herein.

Power system 112 is comprised of a hybrid solar power system 124, a battery charging system 118, a battery 120, and an energy management system 122. Battery 120 can be any type of battery commonly used in the art, such as a lithium-ion battery, a nickel metal hydride battery, a nickel-cadmium battery, or a bi-directional fuel cell. Battery 120 can provide an electrical power storage medium so that power system 112 can provide electrical power to the near space vehicle 100 during hours when there is no sunlight.

Hybrid solar power system 124 is comprised of the solar energy collector 114 and a thermal energy converter 116 for providing optimized solar energy conversion whereby directly converting photons to electrical power and supplying the same to the near space vehicle 100. Hybrid solar power system 124 converts solar energy into a sufficient amount of electrical power to support the near space vehicle's 100 propulsion system 110 and electrical systems 102, 104, 106, 108. According to one embodiment, the power system 112 can provide a continuous output of electrical power twenty four (24) hours a day, seven (7) days a week, such that the near space vehicle can operate at a high altitude for an extended period of time (i.e., days, weeks, or months). Power system 112 will be described in further detail below.

A person skilled in the art will further appreciate that near space vehicle 100 hardware architecture is one embodiment of a hardware architecture in which the methods and apparatus described below can be implemented. However, the invention is not limited in this regard and other suitable near space vehicle hardware architectures can be used without limitation. For example, the near space vehicle 100 can be absent of the battery charging system 118. In such a scenario, the near space vehicle 100 hardware architecture can be adjusted accordingly.

System for Powering a Near Space Vehicle

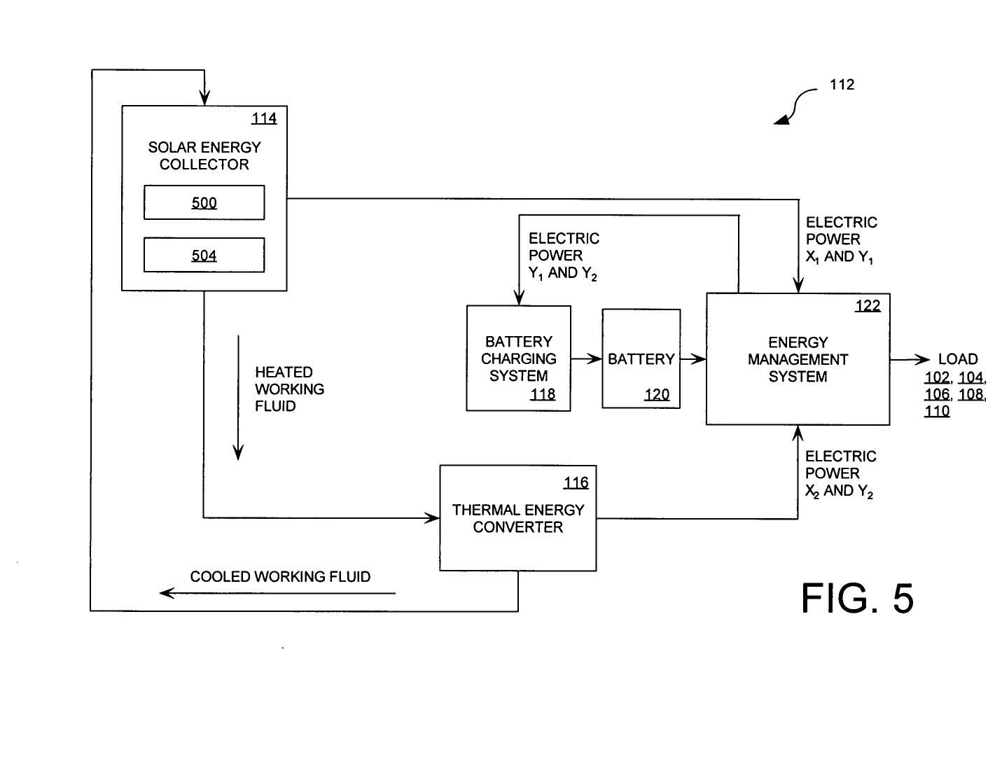

FIG. 5 is a block diagram of a power system that is useful for understanding the invention. As shown in FIG. 5, the power system 112 is comprised of solar energy collector 114, thermal energy converter 116, battery charging system 118, battery 120, and energy management system 122. Solar energy collector 114, described in detail below, is coupled to the energy management system 122 and the thermal energy converter 116. Solar energy collector 114 is comprised of a photovoltaic array 500 that converts sunlight into electric power. The photovoltaic array 500 is electrically connected to the battery charging system 118 through the energy management system 122. The photovoltaic array 500 can supply the battery charging system 118 with all or a portion of its generated electric power. As shown in FIG. 5, the energy management system 122 is coupled to the battery charging system 118 and can direct the electric power Y₁ generated by the photovoltaic array 500 to the battery charging system 118 for charging the battery 120. In this regard, it should be appreciated that the electric power supplied by the photovoltaic array 500 to the battery charging system 118 is controlled by the energy management system 122.

The battery charging system 118 includes a battery charging circuit. The battery charging system 118 is programmed to selectively provide a charging current to the battery charging circuit during periods when the solar energy collector 114 is exposed to solar radiation. The charging current and the amp-hour rating of the battery 120 can be selected so that battery 120 charged by the battery charging circuit has power to continuously operate a load during periods when the solar energy collector 114 is not exposed to solar radiation. For example, the load can include one or more systems onboard the near space vehicle 100 that are operated during nighttime operations. Battery charging systems 118 are well known to persons skilled in the art. Thus, battery charging systems will not be described in detail herein.

Similarly, the photovoltaic array 500 is electrically connected to energy management system 122 and can supply all or a portion of its generated electric power to energy management system 122 for powering the propulsion system 110 and/or the electrical systems 102, 104, 106, 108. In this regard, it should be appreciated that the energy management system 122 is part of an electrical power distribution system that includes one or more circuits configured for distributing electric power to one or more systems onboard the near space vehicle 100. For example, energy management system 122 can control battery charging system 118, and can direct power to propulsion system 110 and/or electrical systems 102, 104, 106, 108. Energy management systems are well known to persons skilled in the art. Thus, energy management system will not be described in detail herein.

Solar energy collector 114 is comprised of a thermal energy collector 504 including a working fluid which is used to cool the photovoltaic array 500. In this regard it will be appreciated that the working fluid also collects thermal energy from solar radiation. The working fluid is circulated through the thermal energy collector 504 and the thermal energy converter 116. The working fluid is heated as it circulates through the thermal energy collector 504 and cools the photovoltaic array. The heated working fluid passes through the thermal energy converter 116 to generate electric power. One embodiment of the present invention uses a low vapor state liquid as the working fluid. In the thermal energy collector 504, a liquid working fluid is transformed into a gaseous working fluid by means of latent heat vaporization. Thermal energy converter 116 can supply the energy management system 122 with all or a portion of the electric power it generates.

It should be appreciated that the thermal energy converter 116 is coupled to the battery charging system 118 through the energy management system 122. The thermal energy converter 116 can supply the battery charging system 118 with all or a portion of the electric power it generates. As shown in FIG. 5, the energy management system 122 is coupled to the battery charging system 118 and can direct the electric power Y₂ generated by the thermal energy converter 116 to the battery charging system 118. In this regard, it should be appreciated that the electric power supplied by the thermal energy converter 116 to the battery charging system 118 is controlled by the energy management system 122.

Power system 112 can be designed to support all of the power requirements of the near space vehicle 100. For example, a near space vehicle's propulsion system 110 and electrical systems 102, 104, 106, 108 require X kilowatts (where, X=X₁+X₂) of electric power for operation. Battery charging system 118 requires Y kilowatts (where, Y=Y₁+Y₂) of electric power to fully charge battery 120 during daylight hours. Photovoltaic array 500 can be designed to convert a sufficient amount of solar energy into Y₁+X₁ kilowatts of electric power. The thermal energy collector 504 can be designed to collect a sufficient amount of solar energy such that thermal energy converter 116 outputs Y₂+X₂ kilowatts of electric power. A person skilled in the art will appreciate that the electric power generated by the photovoltaic array 500 and the thermal energy converter 116 can be managed in accordance with a near space vehicle application (i.e., all or a portion of the electric power generated from photovoltaic array and/or thermal energy converter 116 can be supplied to battery charging system 118 and/or energy management system 122).

For example, near space vehicle 100 with a payload capacity of about three hundred (300) pounds can nominally require about ten (10) kilowatts for operation. Battery charging system 118 can nominally require about nineteen (19) kilowatts to fully charge battery 120. A photovoltaic array 500 can be provided which can generate fifteen (15) kilowatts of electric power. Photovoltaic array 500 can supply all of the fifteen (15) kilowatts to battery charging system 118 (i.e., X₁=zero (0) kilowatts, Y₁=fifteen (15) kilowatts). A thermal energy converter 116 can be provided which is also capable of generating about fifteen (15) kilowatts of electric power. Thermal energy converter 116 can supply four (4) kilowatts to battery charging system 118 and ten (10) kilowatts to energy management system 122 for powering near space vehicle's 100 propulsion system 110 and electrical systems 102, 104, 106, 108 (i.e., X₁=ten (10) kilowatts, Y₁=four (4) kilowatts). Still, a person skilled in the art will appreciate that the invention is not limited in this regard. The electric power generated by the photovoltaic array 500 and the thermal energy converter 116 can be distributed in accordance with a near space vehicle's power system application.

A person skilled in the art will appreciate that power system 112 architecture is one embodiment of a power system architecture having a solar energy collector 114 in which the methods described below can be implemented. However, the invention is not limited in this regard and other suitable power system architectures can be used without limitation. For example, the power system 112 can be absent of the battery charging system 118. In such a scenario, the power system 112 architecture can be adjusted accordingly.

Hybrid Solar Energy Collector

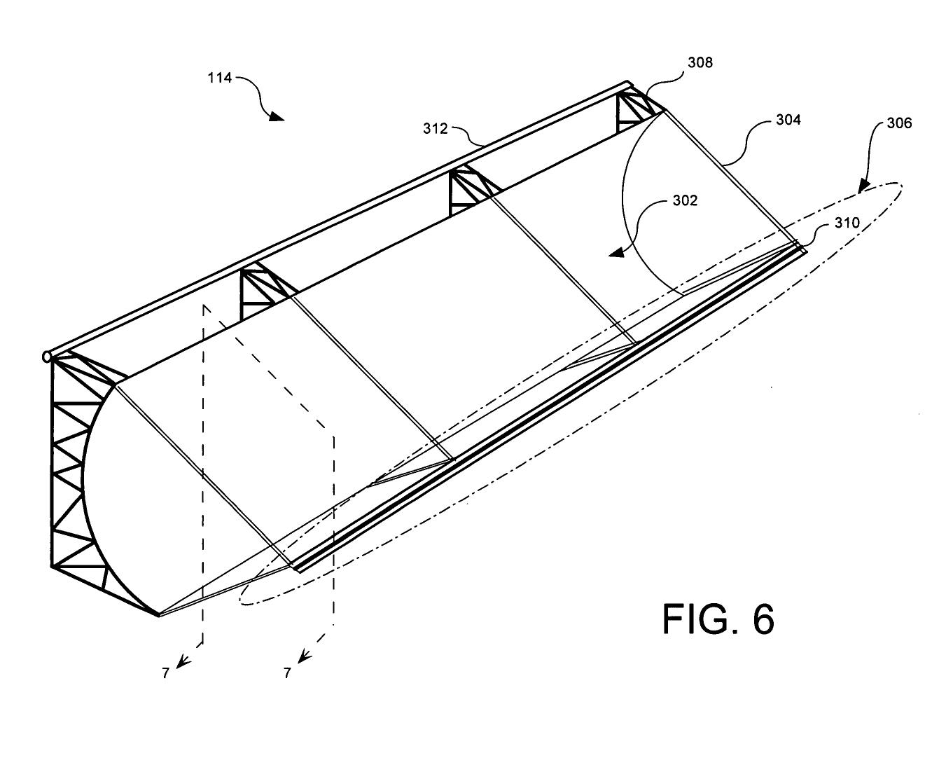

Referring now to FIG. 6, solar energy collector 114 is comprised of a reflective surface 302 and a solar energy collection zone 306. Reflective surface 302 is a solar concentrator formed into a shaped surface for focusing solar radiation. The shaped surface can concentrate solar energy, at an intensity greater than its incident intensity, toward the solar energy collection zone 306 when the reflective surface is exposed to sunlight. In the embodiment shown in FIG. 6, the solar energy collection zone 306 is advantageously disposed substantially along a focal center (or a focal line) of the reflective surface. According to one embodiment, the reflective surface 302 has a linear parabolic shape as shown in FIG. 6. However, the invention is not limited in this regard. Any other suitably shaped surface can be used for focusing solar energy toward the collection zone 306 provided that it has the ability to concentrate solar energy to a sufficient extent required for a particular application. Reflective surface 302 can be comprised of a reflective material commonly used in the art, such as a reflective film (e.g., aluminized film), mylar, or a silvered glass.

According to an embodiment of the invention, reflective surface 302 is formed into a shape for concentrating solar radiation. For example, the reflective surface 302 can concentrate solar energy up to three hundred (300) times its incident intensity depending upon the arrangement of the reflective surface and the measured location within the collection zone 306. Still, a person skilled in the art will appreciate that the invention is not limited in this regard. The concentration ratio can be selected in accordance with a solar energy collector 114 application.

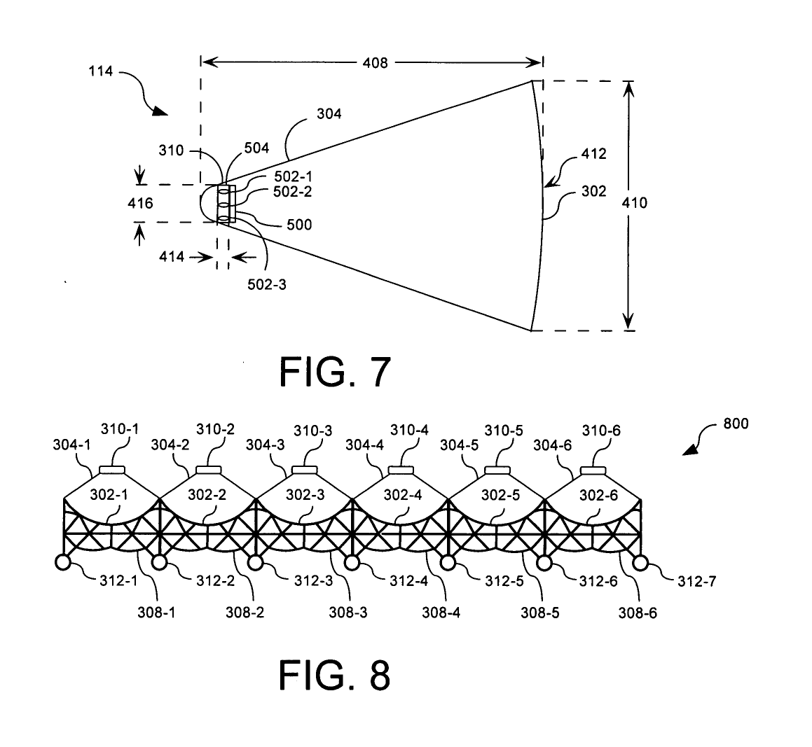

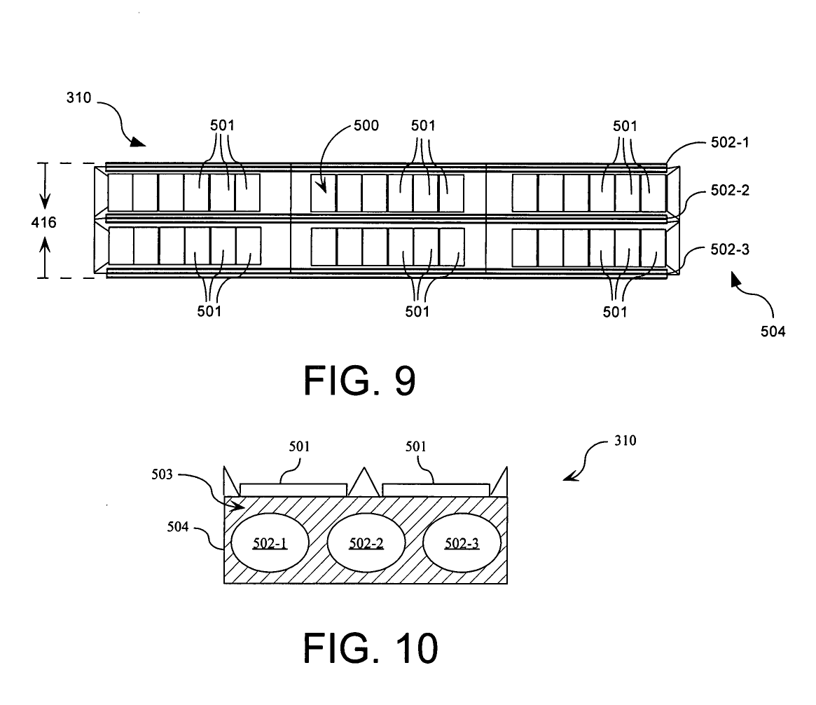

Photovoltaic array 500 and thermal energy collector 504 (collectively, PV/thermal device 310) will now be described in greater detail with respect to FIG. 7, FIG. 8, and FIG. 9. PV/thermal device 310 is fixed in a position at the focal center (or along the focal line) of the shaped reflective surface 302. For example, the PV/thermal device 310 can be maintained in position by means of a rigid frame 304. Those skilled in the art will appreciate that only a portion of the PV/thermal device 310 can be positioned precisely on the focal center (or on the focal line) of the reflective surface 302 so as to receive a highest concentration of solar energy. Those portions of the PV/thermal device 310 which are positioned away from this focal center (or this focal line) will receive a somewhat lower concentration of solar energy. Consequently, the concentration ratio of thermal energy can vary somewhat. For example, the concentration ratio can vary broadly over the surface of the PV/thermal device 310. Notably, a shaped surface having a focal center (or a focal line) can advantageously provide a sufficient amount of heat at the PV/thermal device 310 to create a large temperature differential between the PV/thermal device 310 and the near space atmosphere.

Rigid frame 304 can be made from any suitable material, such as a metal, metal alloy, composite, fiber reinforced plastic, or polymer material. Rigid frame 304 is coupled to a support structure 308. Support structure 308 can be attached to a truss tube 312. Support structure 308 is also coupled to a support pedestal 152 of near space vehicle 100, such that reflective surface 302 can face the sun during daylight hours.

Referring now to FIG. 7, a cross-sectional view of solar energy collector 114 is provided. Solar energy collector 114 has a width 408. Reflective surface 302 has a height 410. Reflective surface 302 is comprised of a curved surface having a curvature 412. PV/thermal device 310 has a height 414 and a width 416. Width 408, 416, height 410, 414, and curvature 412 can be selected in accordance with a solar energy collector 114 application. For example, a desired electric power output of the hybrid solar power system 124 can dictate the sizing of the reflective surface 302 and the PV/thermal device 310. As shown in FIG. 7, PV/thermal device 310 is comprised of a thermal energy collector 504 and a photovoltaic array 500. Thermal energy collector 504 is comprised of one or more fluid conduits 502-1, 502-2, 502-3 to provide passageways for the flow of a working fluid.

Referring now to FIG. 8, it will be appreciated that instead of using just one solar energy collector 114, two or more such solar energy collectors 114 can be arranged in rows and/or columns to form an array 800. Array 800 can be comprised of support structures 308-1, 308-2, 308-3, 308-4, 308-5, and 308-6. The support structures can be attached to truss tubes 312-1, 312-2, 312-3, 312-4, 312-5, 312-6, and 312-7. The support structures can support reflective surfaces 302-1, 302-2, 302-3, 302-4, 302-5, and 302-6. Further, a set of rigid frames 304-1, 304-2, 304-3, 304-4, 304-5, 304-6 attached to the support structures can be used to position a plurality of PV/thermal devices 310-1, 310-2, 310-3, 310-4, 310-5, 310-6.

Although it can be advantageous to focus incident light toward a solar energy collection zone, it will be appreciated that excessive amounts of heat can damage the photovoltaic array. Accordingly, it can be advantageous to provide a cooling mechanism for the photovoltaic array. Referring now to FIG. 9, a top view of PV/thermal device 310 is provided. FIG. 10 is a cross-sectional view of the PV/thermal device 310 taken along line 10-10. Referring to FIG. 9, it can be observed that the thermal energy collector 504 is comprised of one or more fluid conduits 502-1, 502-2, 502-3 to provide passageways for the flow of a working fluid. The fluid conduits can be arranged in a linear path or can follow a serpentine path through the thermal energy collector to maximize heat transfer. A thermal interface 503 is disposed between the fluid conduits 502-1, 502-2, 502-3 and the solar cells 501 that form the solar array. Thermal interface 503 can be comprised of any suitable material that provides efficient thermal conduction of heat from the solar cells 501 to the fluid contained in the fluid conduits.

The flow of the working fluid through the one or more fluid conduits 502-1, 502-2, 502-3 can be produced by compressing the fluid before it enters the fluid conduits 502-1, 502-2, 502-3. As the working fluid is heated by solar energy, it can change from a liquid state to a gaseous state. Alternatively, mechanical means (e.g., a circulating pump or a fan) can be used to create flow of the working fluid through fluid conduits 502-1, 502-2, 502-3. The fluid conduits 502-1, 502-2, 502-3 can be comprised of any material that is a good thermal conductor capable of constraining the fluid.

Photovoltaic array 500 can substantially cover a surface of PV/thermal device 310 exposed to sunlight from reflective surface 302. Fluid conduits 502-1, 502-2, 502-3 and photovoltaic array 500 are positioned such that the photovoltaic array 500 is cooled by a working fluid circulating through the passageways. For example, photovoltaic array 500 can be arranged in one or more rows running parallel and adjacent to fluid conduits 502-1, 502-2, 502-3. The thermal interface 503 can be provided between the photovoltaic array 500 and the fluid conduits 502-1, 502-2, 502-3 to provide a path for transferring thermal energy directly from photovoltaic array 500 to thermal energy collector 504.

Photovoltaic cells 501 typically include a base material, such as silicon, copper indium diselenide, or cadmium telluride. The base material can be a mono-crystalline base material, a multi-crystalline base material, or an amorphous base material. Photovoltaic cells 501 are often thin wafers having a base material and/or other nonmetallic elements, such as boron. Photovoltaic cell's 501 front surface is often composed of a metallic grid for enabling an electrical connection to an external device. Similarly, photovoltaic cell's 501 back surface can be composed of a metallic material, coextensive with its surface area, for enabling an electrical connection to an external device.

According to an embodiment of the invention, photovoltaic array 500 is selected to include one or more high efficiency photovoltaic cells. For example, the photovoltaic cells 501 can have an efficiency of about twenty eight (28) percent. Still, a person skilled in the art will appreciate that the invention is not limited in this regard. Photovoltaic array 500 can be selected to include photovoltaic cells 501 in accordance with a particular PV/thermal device 310 application.

A person skilled in the art will appreciate that the hybrid solar energy collector 114 architecture of FIG. 6, FIG. 7, FIG. 8, and FIG. 9 is one embodiment of a hybrid solar energy collector in which the methods described below can be implemented. However, the invention is not limited in this regard and any other suitable hybrid solar energy collector architecture having a photovoltaic array 500 and a thermal energy collector 504 can be used without limitation.

Thermal Energy Converter and Thermal Energy Conversion Flow Process

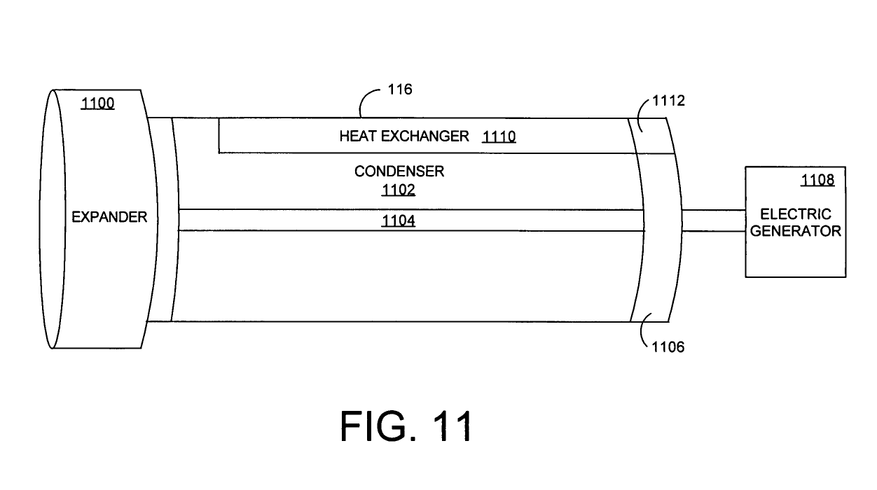

FIG. 11 is a schematic illustration of a thermal energy converter according to an embodiment of the invention. Thermal energy converter 116 is an engine comprised of an expander 1100, a condenser 1102, a shaft 1104, a compressor 1106, and an electric generator 1108. Expander 1100, driven by a flow of a working fluid, is coupled to shaft 1104 such that expander 1100 rotates shaft 1104. Expander 1100 can be a type of expander capable of extracting work from the flow of the working fluid (e.g., a steam engine). Shaft 1104 drives electric generator 1108 to produce electric power from mechanical energy. Condenser 1102 converts a working fluid from a gas to a liquid (i.e., removes heat from the working fluid). Condenser 1102 is comprised of a heat exchanger 1110 configured for transferring thermal energy from the working fluid circulating through heat exchanger 1110 to a very cold ambient air flowing across its outer surface. Notably, this ambient air is essentially in infinite supply at near space altitudes. Thermal energy converter 116 is also comprised of a compressor 1112 that compresses the working fluid after circulating through heat exchanger 1110. Compressor 1106 also compresses the working fluid to reduce its volume.

According to an embodiment of the invention, thermal energy converter 116 is advantageously selected to produce electric power at a high efficiency rate. For example, thermal energy converter 116 is designed to reasonably achieve a very high conversion efficiency. Still, a person skilled in the art will appreciate that the invention is not limited in this regard. Thermal energy converter 116 can produce electric power at an efficiency rate consistent with available current technology that is in accordance with a particular hybrid solar power system 124 application.

A person skilled in the art will appreciate that the thermal energy converter 116 architecture is one embodiment of a thermal energy converter architecture in which the methods described below can be implemented. However, the invention is not limited in this regard and any other suitable thermal energy converter architecture can be used without limitation, provided that it operates with a relatively high degree of efficiency.

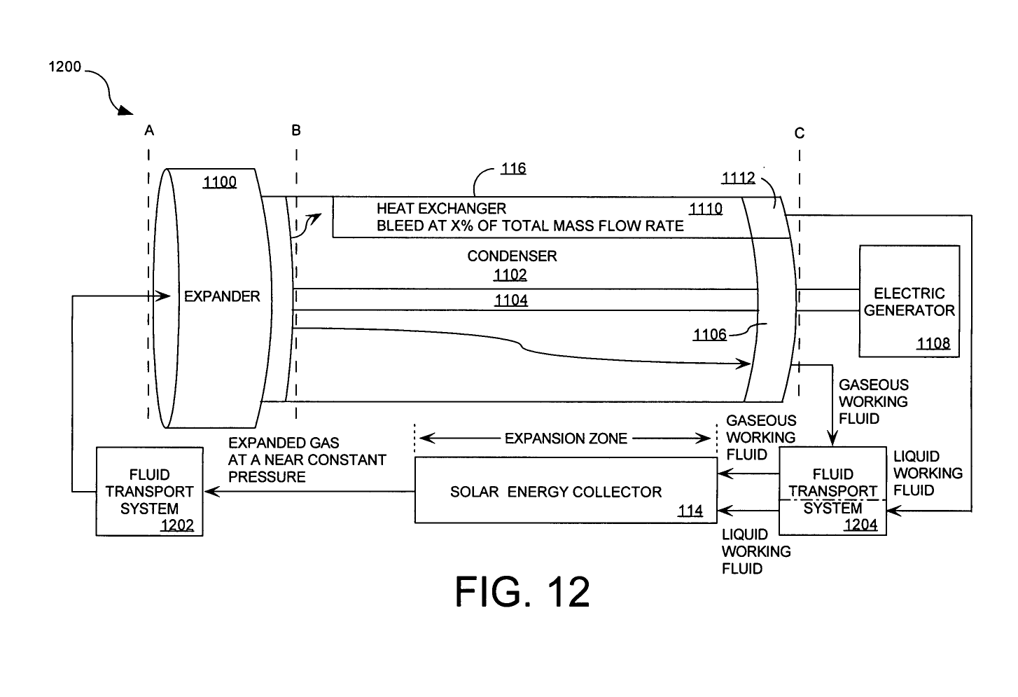

Referring now to FIG. 12, a thermal energy conversion flow process 1200 is provided that utilizes a heat transfer cycle (for example, a Stirling cycle) for the conversion of thermal energy into electric power. A Stirling cycle is well known and involves heating a working fluid to increase its pressure and create a fluid motive drive pressure. The pressurized working fluid flows through expander 1100 to create work. Subsequently, the working fluid is cooled to decrease its pressure and create a constant fluid flow through expander 1100.

Referring again to FIG. 12, the thermal energy conversion flow process 1200 begins when a working fluid circulates under pressure through solar energy collector 114. As the pressurized working fluid circulates through solar energy collector 114, thermal energy is transferred to the working fluid. This transfer of thermal energy causes a change in the state of the working fluid from a liquid state to a gaseous state which results in the expansion of the working fluid. After changing state, the working fluid flows towards the fluid transport system 1202. The fluid transport system 1202 (e.g., a pipeline) communicates the pressurized working fluid from solar energy collector 114 to thermal energy converter 116. The working fluid enters thermal energy converter 116 at point A where the motive drive pressure equals P1. As the gaseous working fluid flows through thermal energy converter 114, the expander 1100 is driven by the flow of the pressurized working fluid such that it rotates shaft 1104. The shaft 1104 drives the electrical generator 1108 to produce electric power. After flowing through the expander 1100, a portion of the gaseous working fluid continues to flow to the condenser 1102. This gaseous working fluid then flows to the compressor 1106 where its volume can be reduced. The working fluid exits the compressor 1106 at point C where the motive drive pressure equals a value that is slightly higher than P1. Subsequently, the pressurized working fluid flows into the fluid transport system 1204 (e.g., a pipeline for a gaseous working fluid). The fluid transport system 1204 communicates the working fluid from the compressor 1106 to the solar energy collector 114.

The remaining portion of the gaseous working fluid flows through the expander 1100 and continues to flow to the heat exchanger 1110 which uses ambient air as a coolant. The heat exchanger 1110 is configured to transfer (i.e., bleed) thermal energy from the portion of the gaseous working fluid to an ambient air at X % of the gaseous working fluid's mass flow rate. This process results in a pressure drop from point A to point B, i.e., the motive drive pressure at point A equals P1 and the motive drive pressure at point B equals P2 where P2 equals P1−X % bleed. It should be understood that the bleed of the working fluid is the portion of the gaseous working fluid allowed to be condensed to a liquid working fluid. The pressure drop between point A and point B provides a constant fluid flow through the expander 1100. The liquid working fluid then flows to compressor 1112 where its volume can be reduced. The liquid working fluid exits compressor 1112 at point C where the motive drive pressure equals a value that is slightly higher than P1. Subsequently, the pressurized working fluid flows into a fluid transport system 1204 (e.g., a pipeline for a liquid working fluid). The fluid transport system 1204 communicates the liquid working fluid from the compressor 1106 to the solar energy collector 114 where the liquid working fluid mixes with the gaseous working fluid and where the liquid working fluid changes from a liquid state to a gaseous state.

According to an embodiment of the invention, the working fluid is selected to include a low vapor state working fluid. For example, the working fluid can be comprised of propane C₃H₈, ammonia NH₃, and butane C₄H₁₀. The working fluid can also be selected to include a hydrocarbon. Still, a person skilled in the art will appreciate that the invention is not limited in this regard. Working fluid can be selected in accordance with the thermal gradient between the solar energy collector 114 and the heat exchanger 1110.

A person skilled in the art will further appreciate that the thermal energy conversion flow process 1200 is one embodiment of the invention. However, the invention is not limited in this regard and any other suitable thermal energy converter flow process can be used without limitation to generate electricity. Specifically, it should be appreciated that any heat transfer cycle can be used with the present invention. In this regard, any Stirling cycle can also be used with the present invention.

Method for Powering a Near Space Vehicle with a Hybrid Solar Power Device and a Battery

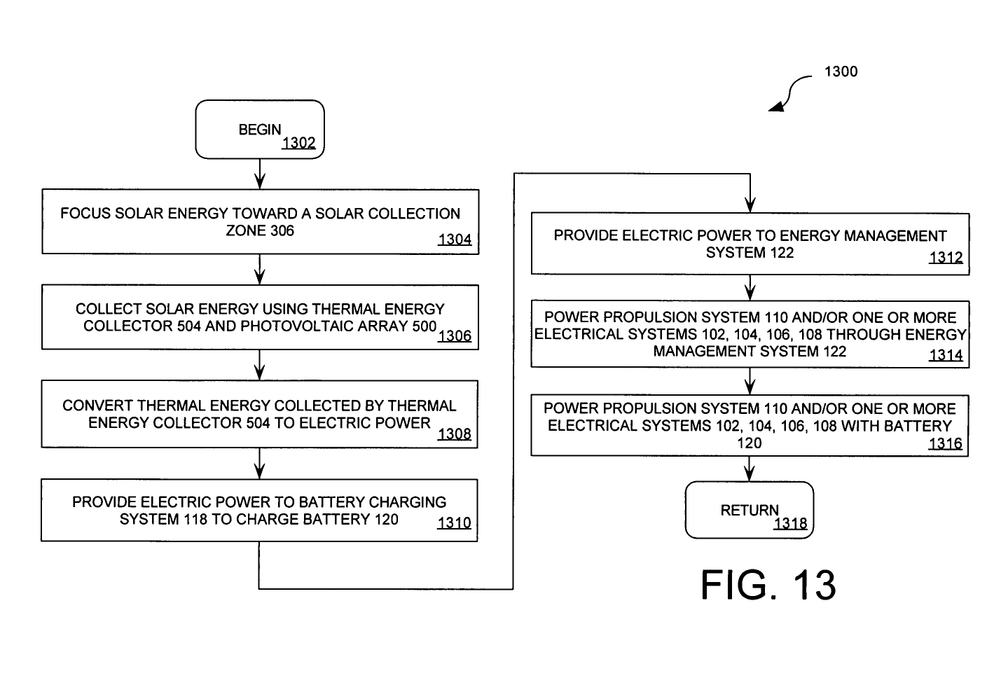

FIG. 13 is a process flow diagram illustrating a method for powering a near space vehicle using power system 112 of FIG. 4 and FIG. 5. Method 1300 begins with step 1302 and continues with step 1304. In step 1304, solar energy is focused towards a solar collection zone 306. In step 1306, solar energy is collected using thermal energy collector 504 and photovoltaic array 500. It will be appreciated that this step also cools the photovoltaic array. The solar energy collected by thermal energy collector 504 is converted into electric power is step 1308. This step can involve transferring thermal energy from thermal energy collector 504 to a working fluid. The working fluid can be transported from thermal energy collector 504 to a thermal energy converter 116 for conversion of thermal energy into electric power. After converting thermal energy into electric power, control is passed to step 1310. In step 1310, electrical power is provided to battery charging system 118. Also, electric power is provided to energy management system 122 in step 1312. After providing electric power to battery charging system 118 and energy management system 122, method 1300 continues with step 1314 where electric power is supplied to propulsion system 110 and/or one or more electrical systems 101, 104, 106, 108 through energy management system 122. Subsequently, control is passed to step 1316 where propulsion system 110 and/or one or more electrical systems 101, 104, 106, 108 are powered with battery 120. After supplying power to propulsion system 110 and one or more electrical systems 101, 104, 106, 108, step 1318 is performed where method 1300 returns to step 1302.

A person skilled in the art will appreciate that method 1300 is one embodiment of a method for powering a near space vehicle 100 using a hybrid solar power device 124 and a battery 120. However, the invention is not limited in this regard and any other suitable method for powering a near space vehicle using a hybrid solar power device and a battery can be used without limitation.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A system for providing continuous electric power from solar energy, comprising:
a PV/thermal device comprising a photovoltaic array and a thermal energy collector comprising a fluid cooling system for said photovoltaic array;
a thermal energy converter having at least one fluid coupling to said fluid cooling system, and configured for converting thermal energy from said fluid cooling system to electric power; and
a battery charging system coupled to at least one of said photovoltaic array and said thermal energy converter.

2. The system according to claim 1, further comprising a solar concentrator formed of an optically reflective material having a curved surface, said curved surface defining a focal center or a focal line toward which light incident on said curved surface is reflected; and wherein said PV/thermal device is positioned substantially at said focal center or along said focal line.

3. The system according to claim 2, wherein said battery charging system comprises a battery charging circuit; and wherein said battery charging system is programmed to selectively provide a charging current for said battery charging circuit during periods when said solar concentrator is exposed to solar radiation.

4. The system according to claim 3, wherein at least one of said photovoltaic array and said thermal energy converter supplies power to a load when said solar concentrator is exposed to solar radiation, and further comprising a battery charged by said charging circuit, said battery having an amp-hour capacity rated to continuously supply power to said load during periods each day when solar radiation is not available.

5. The system according to claim 1, further comprising a thermal interface between said thermal energy collector and said photovoltaic array, said thermal interface defining a thermally conductive path for communicating heat from said photovoltaic array to said thermal energy collector.

6. The system according to claim 2, wherein said thermal energy collector further comprises at least one conduit containing a working fluid.

7. The system according to claim 6, wherein said fluid coupling further comprises a fluid transport system for continuously circulating said working fluid between said thermal energy converter and said thermal energy collector when said solar concentrator is exposed to solar radiation.

8. The system according to claim 7, wherein said thermal energy converter further comprises an engine powered by said working fluid.

9. The system according to claim 8, wherein said thermal energy converter further comprises an electric generator rotated by said engine.

10. The system according to claim 2, further comprising a support structure for said solar concentrator, said support structure comprising at least one movable portion for varying a position of said solar concentrator.

11. The system according to claim 4, wherein said solar concentrator, said PV/thermal device, said thermal energy converter, and said battery charging system are operatively disposed on a vehicle.

12. The system according to claim 11, further comprising an electric power distribution system onboard said vehicle.

13. The system according to claim 12, wherein said electric power distribution system includes at least one circuit configured for distributing power to a propulsion system of said vehicle.

14. The system according to claim 12, wherein said electric power distribution system includes at least one circuit configured for distributing power to electronic equipment onboard said vehicle.

15. The system according to claim 12, wherein said load comprises a vehicle propulsion system and electronic equipment onboard said vehicle.

16. The system according to claim 11, wherein said vehicle comprises a lift system configured for carrying said vehicle to a near space altitude.

17. The system according to claim 16, wherein said thermal energy converter further comprises at least one heat exchanger arranged for transferring heat from a working fluid to an atmosphere surrounding said vehicle.

18. The system according to claim 11, further comprising a control system programmed for controlling at least one of a position of said vehicle and an orientation of said solar concentrator, so that said solar concentrator is constantly pointed toward a source of solar radiation.

19. A method for generating electric power from solar energy, comprising:
exposing to a source of solar radiation a PV/thermal device which includes a photovoltaic array;
cooling said photovoltaic array with a fluid cooling system comprised of a thermal energy collector;
generating electric power with said photovoltaic array and with a thermal energy converter using thermal energy derived from said fluid cooling system; and
using said electric power to selectively charge a battery during periods when said solar concentrator is exposed to solar radiation.

20. The method according to claim 19, further comprising exposing to a source of solar radiation a solar concentrator formed of an optically reflective material having a curved surface that defines a focal center or a focal line toward which light incident on said curved surface is reflected; and positioning substantially at said focal center or along said focal line said PV/thermal device.

21. The method according to claim 20, further comprising supplying electric power to a load during periods when said solar concentrator is exposed to solar radiation.

22. The method according to claim 21, further comprising charging said battery to continuously power said load during periods when said solar concentrator is not exposed to solar radiation.

23. The method according to claim 19, further comprising communicating heat from said photovoltaic array to said thermal energy collector through a thermal interface.

24. The method according to claim 19, further comprising heating at least one working fluid contained within a fluid conduit of said thermal energy collector.

25. The method according to claim 24, further comprising powering an engine with said at least one working fluid.

26. The method according to claim 25, further comprising rotating an electric generator with said engine.

27. The method according to claim 20, further comprising positioning said solar concentrator, said PV/thermal device, and said thermal converter onboard a vehicle, and coupling electric power from at least one of said photovoltaic array and said thermal energy converter to an electric power distribution system onboard said vehicle.

28. The method according to claim 27, further comprising coupling electric power from said electric power distribution system to a propulsion system of said vehicle.

29. The method according to claim 27, further comprising coupling electric power from said electric power distribution system to electronic equipment onboard said vehicle.

30. The method according to claim 27, further comprising positioning said vehicle at a near space altitude.

31. The method according to claim 30, further comprising using a temperature differential between a working fluid and a surrounding atmosphere at said near space altitude to power an engine.

32. The method according to claim 27, further comprising selectively controlling at least one of a position of said vehicle and an orientation of said solar concentrator to constantly point said solar concentrator toward a source of solar radiation when said source of solar radiation is available.
